(19) United States
(12) Patent Application Publication
(10) Pub. No.: US 2009/0004098 A1
(43) Pub. Date: Jan. 1, 2009

(54) Process for the Production of Nanoparticles with Tailor-Made Surface Chemistry and Corresponding Colloids

(75) Inventors: Helmut Schmidt, Saarbruecken-Guedingen (DE); Karl-Peter Schmitt, Grosbliederstroff (FR); Klaus Schmitt, Saarbruecken (DE); Frank Tabellion, Saarbruecken (DE)

Correspondence Address: GREENBLUM & BERNSTEIN, P.L.C., 1950 ROLAND CLARKE PLACE, RESTON, VA, 20191, US

(73) Assignee: Leibniz-Institut Fuer Neue Materialien Gemeinnuetzige GMBH, Saarbruecken (DE)

(21) Appl. No.: 11/574,471

(22) PCT Filed: Oct. 3, 2005
(86) PCT No.: PCT/EP05/10643

§ 371 Date: May 14, 2007

(30) Foreign Application Priority Data
Oct. 4, 2004 (DE) 10 2004 048 230.6

(51) Int. Cl. C01G 25/02; B01F 17/00; B01J 19/12

(52) U.S. Cl. 423/608; 516/9; 204/157.15

(57) ABSTRACT

A process for the production of a suspension of crystalline and/or densified, surface-modified nanoscale particles in a dispersant. The process comprises: (a) heat-treating a suspension of amorphous or semicrystalline, non-surface-modified nanoscale particles in a first dispersant to obtain crystallized and/or densified particles; and (b) mechanically activating, in the presence of at least one modifying agent, the particles obtained according to (a) as a suspension in the first dispersant or in a different dispersant to obtain a suspension of crystalline and/or densified nanoscale particles which are surface-modified by the at least one modifying agent.

The present invention relates to a process for the production of colloids of crystalline and/or densified, surface-modified, nanoscale particles in a dispersant and of powders of these crystalline and/or densified, surface-modified, nanoscale particles.

The production of crystalline ZrO₂ colloids having particle sizes in the lower nanometer range between 1 and 20 nm by hydrothermal synthesis has long been known. It is recognized that the formation of agglomerates under hydrothermal conditions can be substantially prevented by using stabilizing and/or surface-blocking substances, and hence highly disperse sols or modified ZrO₂ particles are obtainable.

Thus, EP-A-0229657 and U.S. Pat. No. 4,784,794 describe the production of highly disperse, monoclinic ZrO₂ sols by hydrothermal reaction of aqueous, zirconium-containing precursors, which are obtained by the reaction of zirconyl chloride with water or by dissolution of zirconium salts in hydrochloric acid. Acicular or ellipsoidal ZrO₂ particles having a diameter of less than 10 nm are obtained thereby. A disadvantage of this process is the very long duration of the hydrothermal reaction of more than 24 h, the dilution to below 1 mol/litre, the pH adjustment, which can be effected by means of dialysis, ion exchange, ultrafiltration or addition of bases, and a subsequent concentration being required. This process is moreover limited to the production of ZrO₂ sols which are stabilized in aqueous HCl. Surface modification and doping are not described. Moreover, mechanically activated surface modification with strong shearing is not intended.

U.S. Pat. No. 5,643,497 describes the production of stable aqueous zirconium oxide sols having low surface activity for use as abrasives for semiconductor production. For this purpose, zirconium oxide powder which was obtained from a sol having a particle size between 20 and 500 nm is calcined, and then redispersed in water in the presence of water-soluble acids or bases. Stable ZrO₂ colloids having a particle size of 20 to 1500 nm are obtained. A disadvantage is that the pulverization in a mill takes between 20 and 100 h and is therefore uneconomical. Thus, for example, a milling time of 96 h is required in order to obtain a particle size of 152 nm. Zirconium oxide sols having particle sizes of less than 20 nm cannot be produced by this process.

U.S. Pat. No. 5,935,275 and EP-A-0823885 describe the synthesis of weakly agglomerated nanoscale particles by the use of surface-active substances. The function of the surface-blocking substance is to control the particle size and to form a steric barrier against agglomeration. The surface-blocking substance can be removed from the surface of the particles and replaced by another surface-modifying substance. The removal of a surface-blocking substance is very complicated. In this process, nanoscale particles in the range from 1 to 100 nm are to be produced. A mechanically activated surface modification is not described.

U.S. Pat. No. 5,234,870 describes a process for the production of transparent zirconium oxide sols which are stable in the aqueous neutral and basic range and in organic solvents. The sols produced by hydrolysis at elevated temperature from zirconyl ammonium carbonate in the presence of chelating agents are, however, amorphous and therefore cannot be used for many areas. A mechanically activated surface modification with strong shearing is also not intended here. H. K. Schmidt, R. Nass, D. Burgard and R. Nonninger describe, in Mat. Res. Soc. Symp. Proc. Vol. 520: pages 21 to 31, with the title “Fabrication of agglomerate-free nanopowders by hydrothermal chemical processing”, the production of nanoscale, yttrium-stabilized ZrO₂ by precipitation of Zr(OⁿPr)₄ and Y(NO₃)₃ with aqueous ammonia solution in the presence of oleic acid polyethylene oxide ester (OPE) as a surface-blocking substance with subsequent hydrothermal crystallization. A disadvantage of this process is the complicated removal of the surface-blocking substance. The powder is boiled in 8 n NaOH and toluene for 5 h, and the residue obtained is subsequently washed several times with demineralized water. The subsequent modification is effected by stirring with TODA. A mechanically activated surface modification with strong shearing is not intended.

U.S. Pat. No. 5,037,579 describes a hydrothermal process for the production of zirconium oxide sols, zirconium acetate/glacial acetic acid solution being converted at 160° C. into zirconium oxide sols. The advantage of this process is the use of acetate solution, which permits the use of steel autoclaves. Sols having average particle sizes of 60 to 225 nm are obtained, these particles comprising agglomerates of subunits having an average size of 2 to 3 nm. The low ZrO₂ concentrations of 0.2 to 0.8 mol/litre, the complicated removal of unconverted zirconium acetate and excess glacial acetic acid and the subsequent concentration by ultra-filtration are disadvantages of this process. This process is limited to the production of aqueous ZrO₂ sols stabilized with acetic acid. The use of other surface modifiers or doping of the particles is not described.

U.S. Pat. No. 6,376,590 describes the production of ZrO₂ sols which are said to have an average particle size of 7 to 20 nm. Starting from zirconium polyether carboxylates, which are obtained from zirconium salts and polyether carboxylic acids, ZrO₂ sols are obtained by hydrothermal hydrolysis. In general, the hydrothermal reaction is effected at above 175° C. for 16 to 24 h. The ZrO₂ particles are surface-modified with the corresponding polyether carboxylic acids, i.e. the acid liberated in the reaction serves as a surface-modifying component. A disadvantage of this process is that only a part of the polyether carboxylic acid liberated is required for the surface modification of the particles. The excess part has to be removed by a complicated procedure. The polyether carboxylic acid can also be exchanged for other surface-modifying acids, the use of which, however, likewise requires complicated working-up. Doping of the particles or mechanically activated surface modification with strong shearing is not described.

It is an object of the present invention to be able to produce surface-modified, crystalline and/or densified, doped and undoped nanoparticles, in particular ZrO₂ nanoparticles, or colloids thereof having a mean particle size of not more than 20 nm, which no longer have the various disadvantages of the prior art but can be prepared in a simple and economical manner with high yield and with a surface chemistry which can be adapted specifically to the further requirements of the respective application, without the necessity, during the thermal process, of surface-blocking and/or stabilizing substances which have to be removed and/or exchanged subsequently by additional steps. The process according to the invention should also permit a broad application spectrum with regard to doping, dispersing medium and surface modification of the particles, in particular the ZrO₂ particles or of the colloids thereof.

Surprisingly, this could be achieved by the process of the present invention, with the result that suspensions of colloids of crystalline and/or densified, surface-modified, nanoscale particles, or after removal of the dispersant, a powder of these particles can be obtained in a simple manner and with high yield, it being particularly advantageous that, after the thermal or hydrothermal treatment, the particles are not yet surface-modified so that the surface modification can be effected in a simple manner and especially tailor-made for the subsequent application. Surprisingly, good deagglomeration or deaggregation of the particles is achieved in step b).

Accordingly, the prevent invention provides a process for the production of a suspension of crystalline and/or densified, surface-modified, nanoscale particles or particles in a dispersant, the process comprising the following steps:
a) a suspension of amorphous or semicrystalline, non-surface-modified, nanoscale particles in a dispersant is heat-treated in order to crystallize and/or to densify the particles, and
b) the suspension of the crystallized and/or densified, non-surface-modified, nanoscale particles in the dispersant of step a) or in another dispersant is activated in the presence of a modifier by mechanical stress, so that the particles are surface-modified by the modifier in order to obtain a suspension of crystalline and/or densified, surface-modified, nanoscale particles.

The suspensions obtained are preferably colloidal solutions or colloids or sols. A powder of the crystalline, surface-modified, nanoscale particles can be obtained from the crystalline, surface-modified, nanoscale particles by removal of the dispersant, substantially without agglomeration or aggregation of the particles. Colloids or powders having a mean particle diameter of not more than 20 nm can be obtained by the process according to the invention.

For crystallization and/or densification, the nanoscale starting particles are subjected in step a) to a heat treatment in such a way that the particles are not or will not be surface-modified. Agglomerated or aggregated particles can be obtained thereby, but deagglomeration or deaggregation of the particles surprisingly takes place in step b) so that particles having a mean particle diameter of not more than 20 nm and even down to below 1 nm can be obtained.

It is particularly advantageous that it is possible to start from non-surface-modified particles in step b), so that the surface modification can be adapted in the tailor-made manner to the intended use. Complicated removal of a surface modification present on the particles and subsequent functionalization with suitable groups are not required.

Firstly, complicated process steps such as the removal of the surface modifiers required in the production and/or crystallization are avoided by this novel process and secondly powders or colloids optimized for the application can be produced by the mechano-chemical deagglomeration or deaggregation step.

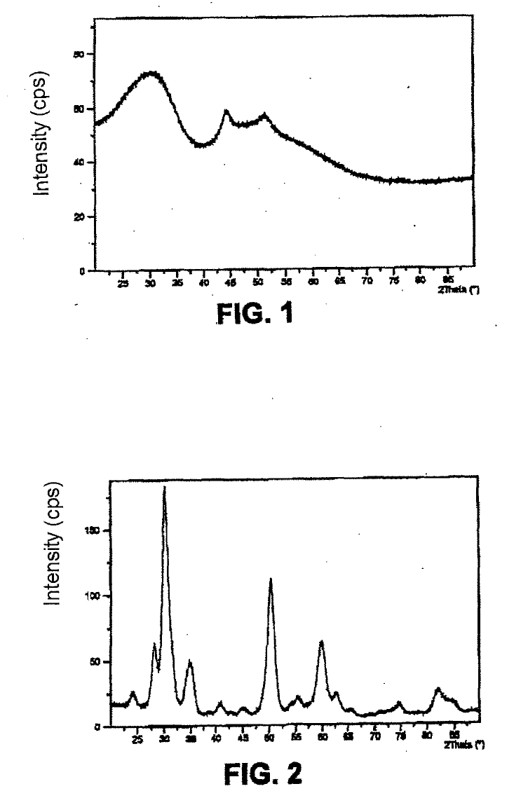

FIG. 1 shows an X-ray diffraction diagram of ZrO₂ particles which are used as starting material for the process according to the invention. FIG. 2 shows an X-ray diffraction diagram of the ZrO₂ particles of FIG. 1 after the heat treatment of the invention.

In step a), a suspension of amorphous or semi-crystalline, non-surface-modified, nanoscale particles in a dispersant is subjected to a heat treatment, no modifiers which lead to surface modification of the particles under the conditions used being present. Without modifiers, the heat treatment always leads to more or less pronounced agglomeration/aggregation of the particles (van-der-Waals forces/particle growth).

The particles used are solid particles or solid-state particles of any desired suitable material. They may preferably be inorganic particles. Examples of inorganic particles are particles of an element, of an alloy or of an elemental compound. The inorganic particles preferably consist of metals, alloys and in particular of metal compounds and compounds of semiconductor elements, such as Si or Ge, or boron.

Examples of particles comprising an element are particles of carbon, such as carbon black or active carbon, comprising a semiconductor, such as silicon (including technical-grade Si, ferrosilicon and pure silicon) or germanium, or a metal, such as, for example, iron (including steel), chromium, tin, copper, aluminium, titanium, gold and zinc. Examples of particles comprising an alloy may be particles of bronze or brass.

Examples of the preferred metal compounds and compounds of semiconductors or boron are oxides which are optionally hydrated, such as ZnO, CdO, SiO₂, GeO₂, TiO₂, aluminium-coated rutile, ZrO₂, CeO₂, SnO₂, Al₂O₃ (in all modifications, in particular as corundum, boehmite, AlO(OH), including aluminium hydroxide), manganese oxides, In₂O₃, Y₂O₃, La₂O₃, iron oxides, such as Fe₂O₃, Cu₂O, Ta₂O₅, Nb₂O₅, V₂O₅, MoO₃ or WO₃, BaO and CaO, corresponding mixed oxides, e.g. indium tin oxide (ITO), antimony tin oxide (ATO), fluorine-doped tin oxide (FTO), calcium tungstate, and those having a perovskite structure, such as BaTiO₃, BaSnO₃ and PbTiO₃, chalcogenides, such as, for example, sulphides (e.g. CdS, ZnS, PbS and Ag₂S), selenides (e.g. GaSe, CdSe and ZnSe) and tellurides (e.g. ZnTe or CdTe), halides, such as AgCl, AgBr, AgI, CuCl, CuBr, CdI₂ and PbI₂, carbides, such as CdC₂ or SiC, silicides, such as MoSi₂, arsenides, such as AlAs, GaAs and GeAs, antimonides, such as InSb, nitrides, such as BN, AIN, Si₃N₄ and Ti₃N₄, phosphides, such as GaP, InP, Zn₃P₂ and Cd₃P₂, and carbonates, sulphates, phosphates, silicates, zirconates, aluminates and stannates of elements, in particular of metals or Si, e.g. carbonates of calcium and/or magnesium, silicates, such as alkali metal silicates, talc, clays (kaolin) or mica, and sulphates of barium or calcium. Further examples of expedient particles are furthermore magnetite, maghemite, spinels (e.g. MgO.Al₂O₃), mullite, eskoalite, tialite, SiO₂.TiO₂, or bioceramics, e.g. calcium phosphate and hydroxyapatite. They may also be particles of glass or ceramics.

They may be, for example, particles which are usually used for the production of glass (e.g. borosilicate glass, soda-lime glass or silica glass), glass ceramic or ceramic (for example based on the oxides SiO₂, BeO, Al₂O₃, ZrO₂ or MgO or the corresponding mixed oxides, electroceramics and magnetoceramics, such as titanates and ferrites, or non-oxide ceramics, such as silicon nitride, silicon carbide, boron nitride or boron carbide). They may also be particles which serve as fillers or pigments. Industrially important fillers are, for example, fillers based on SiO₂, such as quartz crystobalite, tripolite, novaculite, kieselguhr, silica, pyrogenic silicas, precipitated silicas and silica gels, silicates, such as talc, pyrophyllite, kaolin, mica, muscovite, phlogopite, vermiculite, wollastonite and perlites, carbonates, such as calcites, dolomites, chalk and synthetic calcium carbonates, carbon black, sulphates, such as barite and gypsum, micaceous iron ore, glasses, aluminium hydroxides, aluminium oxides and titanium dioxide.

It is also possible to use mixtures of these particles. Particularly preferred materials for the particles are oxide particles or hydrated oxide particles, in particular metal oxides or semimetal oxides, hydrated metal oxides or semimetal oxides or mixtures thereof. Oxides or hydrated oxides of at least one element selected from Mg, Ca, Sr, Ba, Al, Si, Sn, Pb, Bi, Ti, Zr, V, Mn, Nb, Ta, Cr, Mo, W, Fe, Co, Ru, Zn, Ce, Y, Sc, Eu, In and La or mixtures thereof are preferably used. Particularly preferred examples are ZrO₂, TiO₂, SnO₂, ITO (indium tin oxide), ATO (antimony-doped tin oxide), In₂O₃, Y₂O₃, CeO₂, BaTiO₃, SnTiO₃, ZnO, BaO and CaO, which are optionally hydrated.

The production of the starting particle can be effected in a customary manner, for example by flame pyrolysis, plasma methods, gas-phase condensation methods, colloid techniques, precipitation methods, sol-gel processes, controlled nucleation and growth processes, MOCVD methods and (micro)emulsion methods. These methods are described in detail in the literature. The particles are preferably obtained by the sol-gel method or precipitation method. Suitable particles are also commercially available. Thus, for example, commercially available sols, such as, for example, zirconium oxide sols from Nyacol, may be used.

The particles may also be doped, preferably with at least one other metal. For doping, any suitable metal compound can be added during the production of the particles, for example an oxide, a salt or a complex compound, e.g. halides, nitrates, sulphates, carboxylates (e.g. acetates) or acetylacetonates, which are used as molecular precursors in the production of the particles. The other metal may occur in any suitable oxidation state in the compound. Examples of suitable metals for the metal compounds are W, Mo, Zn, Cu, Ag, Au, Sn, In, Fe, Co, Ni, Mn, Ru, V, Nb, Ir, Rh, Os, Pd and Pt. Particularly preferred metals for doping are Mg, Ca, Y, Sc and Ce, in particular for ZrO₂. Specific examples of metal compounds for doping are Y(NO₃)₃.4H₂O, Sc(NO₃)₃.6H₂O, WO₃, MoO₃, FeCl₃, silver acetate, zinc chloride, copper(II) chloride, indium(III) oxide and tin(IV) acetate. The atomic ratio of doping metal to element of the base compound, e.g. Zr, can be chosen as required and is, for example, 0.0005:1 to 0.2:1.

Non-surface-modified particles in the form of a powder or of a suspension and dispersant may be used as starting material. The powder is suspended in a dispersant. The suspension can be used as it is, or the dispersant can be exchanged by known methods from another dispersant more suitable for the respective purpose. The particles may also be obtained in situ in the dispersant by precipitation of a dissolved precursor. The particles obtained are amorphous or semicrystalline, nanoscale particles which are not surface-modified.

For the production of the starting particles molecular precursors of the particles which are dissolved in a solvent may be subjected, for example, to a condensation and/or precipitation reaction. The molecular precursors may be, for example, hydrolysable compounds, salts or soluble hydroxides. The conversion into solid particles can be effected, for example, by precipitation reaction in which sparingly soluble compounds are formed. The particles are preferably obtained by adding water to the solution of the molecular precursors and/or by changing the pH. The establishment of the pH required for the precipitation can be achieved in principle by using any basic or acidic compound which is soluble in the respective solvent.

Various possibilities for the production of particles are explained below using the production of ZrO₂ as an example. Particles of other, optionally hydrated oxides of elements can be produced analogously for the use of the corresponding compounds of the elements, where Zr is to be replaced in each case by the desired element or a mixture of two or more elements.

Examples of precursors for zirconium oxide are discussed below. Examples of further molecular precursors are Y(NO₃)₃ (optionally hydrated, for Y₂O₃); zinc acetate, manganese acetate; FeCl₂, FeCl₃ (for iron oxides); Al(NO₃)₃ (for Al₂O₃); SnCl₄, SbCl₃ (for tin oxide or ATO); aluminium alcoholates, such as Al(O⁵Bu)₃, titanium alkoxides, such as Ti(OⁱPr)₄ (for aluminium-coated rutile); Ba(OH)₂, titanium alkoxides, such as titanium tetrapropoxide (for barium titanate); Na₂WO₄, calcium carboxylates, such as Ca(O₂Pr)₂ (for calcium tungstate); or InCl₃, SnCl₄ (for ITO).

Examples of useable molecular precursors for Zr are ZrO(NO₃)₂, ZrCl₄ or zirconium alcoholates (Zr(OR₄), in which R is alkyl, preferably C₁-C₄-alkyl). Examples of dopants are mentioned above.

Amorphous or semicrystalline nanoscale particles of ZrO₂ or hydrated ZrO₂ are preferably precipitated from a solution or a sol, which solution or which sol contains zirconium in suitable form, for example as a molecular compound or salt, by changing the pH and/or by addition of water. If doped particles are to be produced the sol or the solution additionally contains one or more doping elements, likewise in the form of molecular precursors, which can be precipitated, for example, as oxide or hydrated oxide. The doping elements are, for example, those which are suitable for the production of glass or ceramic, e.g. Mg, Ca, Y, Sc and Ce.

The zirconium-containing solution or the zirconium-containing sol may be both aqueous and nonaqueous (organic). An aqueous starting solution contains molecular precursors containing Zr in dissolved form and molecular precursors optionally containing doping elements which precursors can be precipitated by changing the pH as an oxide or hydrated oxide Zr, which is optionally doped. Corresponding nonaqueous solutions may contain corresponding molecular precursors which can be precipitated without a pH change, for example by simply adding water.

The zirconium-containing molecular precursor which can be precipitated as the oxide or hydrated oxide and optionally the molecular precursors which contain further precipitatable elements for doping are salts which are preferably hydrolysable in aqueous starting solutions; in nonaqueous solutions, hydrolysable compounds and in particular hydrolysable organometallic compounds are preferred. In addition to simple salt solutions, it is also possible to use aqueous sols which can be prepared, for example, by hydrolysing a metal alkoxide, which is dissolved, for example, in a short-chain alcohol (e.g. a C₁-C₃ alcohol), by adding water.

A general process for the production of nanoscale particles from hydrolysable compounds is the sol-gel process. In the sol-gel process, hydrolysable compounds are usually hydrolysed with water, optionally under acidic or basic catalysis, and optionally at least partly condensed. The hydrolysis and/or condensation reactions lead to the formation of compounds or condensates having hydroxyl groups, oxo groups and/or oxo bridges, which serve as precursors. It is possible to use stoichiometric amounts of water, but also smaller or greater amounts. The resulting sol can be adjusted to the viscosity desired for the coating composition by suitable parameters, e.g. degree of condensation, solvent or pH. Further details of the sol-gel process are described, for example, in C. J. Brinker, G. W. Scherer: “Sol-Gel Science—The Physics and Chemistry of Sol-Gel-Processing”, Academic Press, Boston, San Diego, New York, Sydney (1990).

The mean particle diameter of the nanoscale particles used in step a) may be greater than that of the particles obtained by the process according to the invention. At least after step a) has been carried out larger particles are generally present since the particles are then usually present in agglomerated or aggregated form. Nanoscale particles have a mean particle diameter of less than 1 μm. The nanoscale particles used in step a) preferably have a mean particle diameter of less than 0.2 μm.

The nanoscale particles used in step a) are amorphous or semicrystalline. Furthermore, the nanoscale particles used in step a) are non-surface-modified particles, i.e. no modifiers are present on the surface.

Any desired solvent may be used as the dispersant, provided that it does not, or substantially does not, dissolve the particles to be treated. The suitable dispersant is chosen according to the particles to be treated, preferably from water or organic solvents, but inorganic solvents such as, for example, carbon disulphide, are also conceivable.

A particularly preferred dispersant is water, in particular demineralized water. Suitable organic dispersants are both polar and nonpolar and aprotic solvents. Examples of these are alcohols, such as, for example, aliphatic and alicyclic alcohols having 1 to 8 carbon atoms (in particular methanol, ethanol, n-propanol, isopropanol, butanol, octanol and cyclohexanol), ketones, such as, for example, aliphatic and alicyclic ketones having 1 to 8 carbon atoms (in particular acetone, butanone and cyclohexanone), esters, such as, for example, ethyl acetate and glycol esters, ethers, such as, for example, diethyl ether, dibutyl ether, anisole, dioxane, tetrahydrofuran and tetrahydropyran, glycol ethers, such as mono-, di-, tri- and polyglycol ethers, glycols, such as ethylene glycol, diethylene glycol and propylene glycol, amides and other nitrogen compounds, such as, for example, diemthylacetamide, dimethylformamide, pyridine, N-methylpyrrolidone and acetonitrile, sulphoxides and sulphones, such as, for example, sulpholane and dimethyl sulphoxide, nitro compounds, such as nitro-benzene, halohydrocarbons, such as dichloromethane, chloroform, carbon tetrachloride, trichloroethene, tetrachloroethene, ethylene chloride, chlorofluorocarbons, aliphatic, alicyclic or aromatic hydrocarbons, for example having 5 to 15 carbon atoms such as, for example, pentane, hexane, heptane and octane, cyclohexane, benzines, petroleum ether, methyl-cyclohexane, decalin, terpene solvents, benzene, toluene and xylenes. Mixtures of such dispersants can of course also be used.

Preferably used organic dispersants are aliphatic and alicyclic alcohols, such as ethanol, n-propanol and isopropanol, glycols, such as ethylene glycol, and aliphatic, alicyclic and aromatic hydrocarbons, such as hexane, heptane, toluene and o-, m- and p-xylene. Particularly preferred dispersants are ethanol and toluene.

After the suspension of nanoscale particles has been formed or provided by one of the above methods, it is subjected to conditions which lead to densification and/or crystallization of the nanoscale particles. The specific conditions, such as, for example, temperature, pressure and duration do of course depend, for example, on the type and characteristics of the particles used and on the solvent, the procedure and also on one another. For the densification and/or crystallization of the particles, the person skilled in the art can choose the expedient conditions for the respective case based on his technical knowledge. Expedient ranges are stated below. The heat treatment is expediently effected under conditions under which the suspension or exactly the dispersant remains substantially in the liquid phase, i.e. the crystallization/densification takes place in the liquid phase.

For the crystallization and/or densification, the suspension is exposed to an elevated temperature and optionally an elevated pressure. This treatment is preferably effected below the critical data of the solvent present. The elevated temperature must of course also ensure that the solvent does not decompose or decomposes only to an insignificant extent. This treatment can be effected both by the batch process and in a continuous manner. The duration of reaction can be substantially reduced by use of continuously operating systems. In general, the duration of treatment may be, for example, from 1 min to 3 days or from 1 min to 24 h. The duration of treatment, particularly in continuous processes, is in the range from 1 minute to 2 hours, preferably between 5 min and 60 min, particularly preferably between 10 min and 30 min.

For the heat treatment, elevated temperature is understood as meaning in general a temperature of at least 60° C. and particularly preferably at least 80° C. e.g. 120 to 400° C. The heat treatment is particularly preferably effected in a temperature range from 150 to 350° C. The pressure used may be ambient pressure or superatmospheric pressure, for example in a range from 1 to 300 bar. The heat treatment is preferably effected at elevated pressure of more than 1 bar. The pressure may be, for example, at least about 5 bar. An elevated pressure of about 10 to 300 bar is preferably used.

For example the suspension containing the nanoscale particles is preferably introduced into a pressure-resistant container without further pretreatment and optionally treated at an appropriate pressure and an appropriate temperature. Expediently, an autogenous pressure is built up, i.e. the pressure is built up in the closed pressure-resistant container or autoclave by heating, in particular above the boiling point of the solvent.

The treatment is as a rule a lyothermal and preferably a hydrothermal treatment. A hydrothermal treatment is understood in general as meaning a heat treatment of an aqueous solution or suspension under superatmospheric pressure, for example at a temperature above the boiling point of the solvent and a pressure above 1 bar. In the aqueous solution, the dispersant consists of water or preferably substantially comprises water.

Crystalline and/or densified particles are obtained from amorphous or semicrystalline particles by the treatment according to step a). In addition to crystalline phases, semicrystalline particles also comprise amorphous phases, i.e. it is possible to detect amorphous regions. Crystalline particles substantially completely comprise crystalline phase, i.e. substantially no amorphous fraction or no measurable amorphous fraction is present. Here, densified particles are particles which are densified for the most part or preferably substantially to the maximum extent, i.e. further densification is not possible, based on their chemical structure. Nanoparticles may have, for example in the outer region of the particle, less ordered regions which lead to a broadening of the X-ray lines. These regions can be densified by the process of the invention.

Crystallization and densification frequently bring about one another. Thus, densification may frequently be associated with crystallization. In the case of crystallization as a rule densification also takes place. According to the present invention, crystalline, surface-modified, nanoscale particles are preferably obtained, i.e. the particles contain substantially no amorphous fractions. Heat treatment is effected in step a) in order to crystallize the particles. The crystalline particles obtained are then surface-modified in step b). As explained above, such a crystallization is frequently also associated with a densification of the particles.

The fraction of crystalline and amorphous phases in particles can be investigated on the basis of X-ray diffraction diagrams. In the case of crystalline particles, it is usually possible to detect a base line from which individual peaks project. For example X-ray diffraction diagrams of particles having different proportions of crystalline phase are shown in Ullmanns, Encyclopädie der technischen Chemie [Encyclopaedia of Industrial Chemistry], Verlag Chemie, 4th edition, Vol. 5, pages 256 and 257. The person skilled in the art can establish whether an amorphous fraction is still measurable in the particles.

FIG. 1 shows an X-ray diffraction diagram of ZrO₂ particles which were used as starting particles for the process. The diagram shows that amorphous phases are present in the particles. For example, the hump at about 30° indicates that the particles also contain crystalline phases. The particles are therefore semi-crystalline. FIG. 2 shows an X-ray diffraction diagram of the particles of FIG. 1, from which crystalline particles have been obtained after crystallization according to step a). The crystalline particles give, for example, peaks at about 30°, 50° and 60° in the diagram.

Crystallized and/or densified, non-surface-modified, nanoscale particles are obtained in this manner as a suspension in a dispersant and are usually more or less agglomerated or aggregated. The suspension can be used directly as it is or, if another dispersant is more expedient, after exchange of the dispersant in step b). It is also possible to effect an intermediate purification step in order to remove process by-products at least partly or completely in the suspension obtained after step a). In the purification step, the dispersant is preferably replaced at least partly by fresh dispersant, which may be the same as the previous one or a different one.

In the optional purification step, the suspensions of densified or crystallized particles are separated from process by-products such as, for example, alcohols, which are formed by the hydrolysis of alkoxides, or ionic impurities, which form when salt solutions are used, and if necessary concentrated or dried. The removal of the process by-products can be effected by simply removing (even partly) or exchanging the solvent. All methods known to the person skilled in the art are suitable for this purpose.

It is preferable to start from the property that nano-particles agglomerate or flocculate at their isoelectric point. For this purpose, the suspensions obtained from the heat treatment are brought to the corresponding isoelectric pH and flocculated. The adjustment is effected by means of acids and bases. The supernatant which contains the process by-product is removed after sedimentation of the nanoscale particles. The high-solids sedimentation product thus obtained contains the nanoscale particles, and dilute suspensions are once again obtained by adding, for example, distilled water. The process comprising the flocculation and the removal of the supernatant can optionally be repeated until the process by-products have been removed or substantially removed.

In this way, it is possible to produce highly pure suspensions containing high-solids nanoscale particles in an organic solvent or preferably aqueous suspensions. From these, it is possible to produce powders by complete removal of the organic solvent or of the water by methods such as, for example, distillation or freeze drying. It is also possible to produce nonaqueous suspensions from the highly pure aqueous suspensions containing the particles. This can be effected, for example, by methods such as solvent exchange.

In step b) suspensions or colloids of crystalline and/or densified, surface-modified, nanoscale particles are produced from the crystallized and/or densified, non-surface-modified, nanoscale particles obtained in step a), which were optionally subjected to a purification step or a dispersant exchange, by subjecting the suspension directly to a mechanically activated process with strong shearing in the presence of a surface modifier. A specific surface modification and at the same time stabilization of the particles to agglomeration are effected in this procedure. As a rule deagglomeration or deaggregation of the particles is also effected. Powders of the particles can be obtained from the resulting colloids by removing the dispersant.

The particles are mechanically activated in the dispersant in the presence of a modifier, i.e. an interaction of the modifier on the particle or the comminuted particle takes place on mechanical activation in the presence of the modifier, preferably chemical bonding. During this mechanical activation, deagglomeration or deaggregation, i.e. comminution, also generally occurs. The mechanical energy input is in particular so high that the particles are surface-modified. Such a reaction under mechanical stress is also referred to as a chemomechanical reaction.

It is known to the person skilled in the art that groups which cannot be found in this form in the interior of the particle are usually present on the surface of particles. These surface groups are usually functional groups which are in general relatively reactive. For example, residual valencies, such as hydroxyl groups and oxy groups, for example in the case of metal oxide particles, or thiol groups and thio groups, for example in the case of metal sulphides, or amino, amido and imido groups, for example in the case of nitrides, are present on such particles as surface groups.

All compounds which can interact strongly with the surface of the particles, or surfactants, can be used as modifiers. It is also possible to use more than one surface-modifying substance, for example a mixture of at least two of said substances. In a variant of the process the modifier used may also simultaneously act as a dispersant so that the same compound is used for both.

The modifier preferably has at least one functional group which can form a chemical bond with the surface groups of the particles, at least under the conditions of the mechanical activation. The chemical bond is preferably a covalent, ionic or coordinate bond between the modifier and the particle, but also hydrogen bridge bonds. A coordinate bond is understood as a complex formation. Thus, for example, an acid/base reaction according to Brönsted or Lewis, complex formation or esterification can take place between the functional groups of the modifier and the particle.

The functional group which the modifier comprises is preferably a carboxyl group, acid chloride group, ester group, nitrile or isonitrile group, OH group, SH group, epoxide group, anhydride group, acid amide group, primary, secondary or tertiary amino group, Si—OH group, hydrolysable radical of a silane (Si—OR groups explained below) or a C—H-acidic group, as in β-dicarbonyl compounds.

The modifier may also comprise more than one such functional group, such as, for example, in betaines, amino acids or ETDA.

In addition to the at least one functional group which can form a chemical bond with the surface group of the particle, the modifier generally has a molecular ratio which modifies the properties of the particle after linkage of the modifier via the functional group. The molecular radical or part thereof may be, for example, hydrophobic or hydrophilic or may carry a second functional group in order in this way to functionalize, i.e. for example to stabilize, compatibilize, render inert or reactivate the colloidal particles with respect to the environment. In this way, the colloidal particles obtained according to the invention are provided with a function or surface functionalization by this molecular radical. By means of the invention, it is possible to obtain nanoscale particles adapted to the desired use and having tailor-made surface chemistry. Depending on the system, covalent bonds, ionic bonds and complex bonds may be present as principles for coupling to the particles, but hydrogen bridge bonds are also suitable.

Hydrophobic molecular radicals may be, for example, alkyl, aryl, alkaryl, aralkyl or fluorine-containing alkyl groups which, in a suitable environment, can lead to the production of an inert condition or repulsion. Examples of a hydrophilic group would be hydroxyl, alkoxy or polyether groups. The optionally present second functional group of the modifier may be, for example, an acidic, basic or ionic group. It may also be a functional group suitable for a chemical reaction with a selected reactant. The second functional group may be the same as that which is suitable as a functional group for bonding to the particle, so that reference is made to the examples mentioned there. Other examples of a second functional group would be epoxide, acryloyloxy, methacryloyloxy, acrylate or methacrylate groups. Two or more identical or different functional groups of this type may be present. The modifier preferably has a molecular weight of not more than 500, preferably not more than 400 and in particular not more than 200. The compounds are preferably liquid under standard conditions. The functional groups which these compounds carry depend primarily on the surface groups of the solid particles and under desired interaction with the environment. The molecular weight also plays an important role for the diffusion to the freshly formed particle surfaces. Small molecules lead to a more rapid occupation of the surface and thus reduce recombination.

Accordingly, examples of suitable modifiers are saturated or unsaturated mono- or polycarboxylic acids, the corresponding acid anhydrides, acid chlorides, esters and acid amides, amino acids, imines, nitriles, isonitriles, epoxy compounds, mono- and polyamines, β-dicarbonyls, such as β-diketones, silanes and metal compounds which have a functional group which can react with the surface groups of the particles. Particularly preferably used modifiers are silanes, carboxylic acids, β-dicarbonyls, amino acids and amines. The carbon chains of these compounds may be interrupted by O, S or NH groups. One or more modifiers may be used.

Preferred saturated or unsaturated mono- and poly-carboxylic acids (preferably monocarboxylic acids) are those having 1 to 24 carbon atoms, such as, for example, formic acid, acetic acid, propionic acid, butyric acid, pentanoic acid, hexanoic acid, acrylic acid, methacrylic acid, crotonic acid, citric acid, adipic acid, succinic acid, glutaric acid, oxalic acid, maleic acid, fumaric acid, itaconic acid and stearic acid, and the corresponding acid anhydrides, acid chlorides, acid esters and acid amides, for example caprolactam. These abovementioned carboxylic acids also include those whose carbon chain is interrupted by O, S or NH groups. Ether carboxylic acids, such as mono- and polyether carboxylic acids and the corresponding acid anhydrides, acid chlorides, acid esters and acid amides, e.g. methoxy acetic acid, 3,6-dioxaheptanoic acid and 3,6,9-trioxadecanoic acid, are particularly preferred.

Examples of preferred mono- and polyamines are those of the general formula Q₃₋ₙNHₙ, in which n=0, 1 or 2 and the radicals Q, independently of one another, represent alkyl having 1 to 12, in particular 1 to 6 and particularly preferably 1 to 4 carbon atoms, e.g. methyl, ethyl, n-propyl, isopropyl and butyl, and aryl, alkaryl or aralkyl having 6 to 24 carbon atoms, such as, for example, phenyl, naphthyl, tolyl and benzyl, and polyalkyleneamines of the general formula Y₂N(—Z—NH)_{y}—Y, in which Y is independently Q or H, Q being as defined above, y is an integer from 1 to 6, preferably 1 to 3, and Z is an alkylene group having 1 to 4, preferably 2 or 3, carbon atoms. Specific examples are methylamine, dimethylamine, trimethylamine, ethylamine, aniline, N-methylaniline, diphenylamine, triphenylamine, toluidine, ethylenediamine and diethylenetriamine.

Preferred β-dicarbonyl compounds are those having 4 to 12, in particular 5 to 8, carbon atoms, such as, for example, diketones, such as acetylacetone, 2,4-hexane-dione, 3,5-heptanedione, acetoacetic acid, C₁-C₄-alkyl acetoacetates, such as ethyl acetoacetate, diacetyl and acetonylacetone.

Examples of amino acids are β-alanine, glycine, valine, aminocaproic acid, leucine and isoleucine.

Preferably used silanes have at least one non-hydrolysable group or a hydroxyl group; hydrolysable organosilanes which additionally have at least one nonhydrolysable radical are particularly preferably used. Preferred silanes have the general formula (I)

RₐSiX(₄₋ₐ) (I)

in which the radicals R are identical or different and represent nonhydrolysable groups, the radicals X are identical or different and denote hydrolysable groups or hydroxyl groups and a has the value 1, 2 or 3. The value of a is preferably 1.

In the general formula (I), the hydrolysable groups X, which may be identical or different from one another, are, for example, hydrogen or halogen (F, Cl, Br or I), alkoxy (preferably C₁₋₆-alkoxy, such as, for example, methoxy, ethoxy, n-propoxy, isopropoxy and butoxy), aryloxy (preferably C₆₋₁₀-aryloxy, such as, for example, phenoxy), acyloxy (preferably C₁₋₆-acyloxy, such as, for example acetoxy or propionyloxy), alkylcarbonyl (preferably C₂₋₇-alkylcarbonyl, such as, for example, acetyl), amino, monoalkylamino or dialkylamino having, preferably, 1 to 12, in particular 1 to 6, carbon atoms. Preferred hydrolysable radicals are halogen, alkoxy groups and acyloxy groups. Particularly preferred hydrolysable radicals are C₁₋₄-alkoxy groups, in particular methoxy and ethoxy.

The nonhydrolysable radicals R, which may be identical or different from one another, may be nonhydrolysable radicals R with or without a functional group.

The nonhydrolysable radical R without a functional group is, for example, alkyl (preferably C₁₋₈-alkyl, such as methyl, ethyl, n-propyl, isopropyl, n-butyl, sec-butyl and tert-butyl, pentyl, hexyl, octyl or cyclohexyl), alkenyl (preferably C₂₋₆-alkenyl, such as, for example, vinyl, 1-propenyl, 2-propenyl and butenyl), alkynyl (preferably C₂₋₆-alkynyl, such as acetylenyl and propargyl), aryl (preferably C₆₋₁₀-aryl, such as, for example, phenyl and naphthyl) and corresponding alkaryls and aralkyls (e.g. tolyl, benzyl and phenethyl). The radicals R and X may optionally have one or more customary substituents, such as, for example, halogen or alkoxy. Alkyltrialkoxysilanes are preferred. Examples are:

CH₃SiCl₃, CH₃Si(OC₂H₅)₃, CH₃Si(OCH₃)₃, C₂H₅SiCl₃, C₂H₅Si(OC₂H₅)₃, C₂H₅Si(OCH₃)₃, C₃H₇Si(OC₂H₅)₃, (C₂H₅O)₃SiC₃H₆Cl₂, (CH₃)₂SiCl₂, (CH₃)₂Si(OC₂H₅)₂, (CH₃)₂Si(OH)₂, C₆H₅Si(OCH₃)₃, C₆H₅Si(OC₂H₅)₃, C₆H₅CH₂CH₂Si(OCH₃)₃, (C₆H₅)₂SiCl₂, (C₆H₅)₂Si(OC₂H₅)₂, (i-C₃H₇)₃SiOH, CH₂═CHSi(OOCCH₃)₃, CH₂═CHSiCl₃, CH₂═CH—Si(OC₂H₅)₃, CH₂═CHSi(OC₂H₅)₃, CH₂═CH—Si(OC₂H₄OCH₃)₃, CH₂═CH—CH₂—Si(OC₂H₅)₃, CH₂═CH—CH₂—Si(OC₂H₅)₃, CH₂═CH—CH₂—Si(OOCCH₃)₃, n-C₆H₁₃—CH₂—CH₂—Si(OC₂H₅)₃ and n-C₈H₁₇—CH₂—CH₂—Si(OC₂H₅)₃.

The nonhydrolysable radical R having a functional group may comprise, for example, as functional group, an epoxide (e.g. glycidyl or glycidyloxy), hydroxyl, ether, amino, monoalkylamino, dialkylamino, optionally substituted anilino, amido, carboxyl, acryloyl, acryloyloxy, methacryloyl, methacryloyloxy, mercapto, cyano, alkoxy, isocyanato, aldehyde, alkylcarbonyl, acid anhydride and phosphoric acid group. These functional groups are bonded to the silicon atom via alkylene, alkenylene or arylene bridge groups which may be interrupted by oxygen or NH groups. The bridge groups preferably contain 1 to 18, preferably 1 to 8 and in particular 1 to 6 carbon atoms.

Said divalent bridge groups and optionally present substituents, as in the case of the alkylamino groups, are derived from, for example, the abovementioned monovalent alkyl, alkenyl, aryl, alkaryl or aralkyl radicals. The radical R can of course also have more than one functional group.

Preferred examples of nonhydrolysable radicals R having functional groups are glycidyl- or a glycidyloxy-(C₁₋₂₀)-alkylene radical, such as β-glycidyloxyethyl, γ-glycidyloxypropyl, δ-glycidyloxybutyl, ε-glycidyloxy-pentyl, ω-glycidyloxyhexyl, and 2-(3,4-epoxy-cyclohexyl)ethyl, a (meth)acryloyloxy-(C₁₋₆)-alkylene radical, e.g. (meth)acryloyloxymethyl, (meth)acryloyloxyethyl, (meth)acryloyloxypropyl or (meth)acryloyloxybutyl, and a 3-isocyanatopropyl radical. Particularly preferred radicals are γ-glycidyloxypropyl and (meth)acryloyloxypropyl. ((Meth)acryloyl represents methacryloyl or acryloyl).

Specific examples of corresponding silanes are γ-glycidyloxypropyltrimethoxysilane (GPTS), γ-glycidyloxypropyltriethoxysilane (GPTES), 3-isocyanatopropyltriethoxysilane, 3-isocyanatopropyldimethylchlorosilane, 3-aminopropyltrimethoxysilane (APTS), 3-aminopropyltriethoxysilane (APTES), N-(2-aminoethyl)-3-aminopropyltrimethoxysilane, N-[N′-(2′-aminoethyl)-2-aminoethyl]-3-aminopropyltrimethoxysilane, hydroxymethyltriethoxysilane, 2-[methoxy(polyethyleneoxy)propyl]trimethoxysilane, bis(hydroxyethyl)-3-aminopropyltriethoxysilane, N-hydroxyethyl-N-methylaminopropyltriethoxysilane 3-(meth)acryloyloxypropyltriethoxysilane and 3-(meth)acryloyloxypropyltrimethoxysilane.

Furthermore, it is also possible to use silanes which at least in some cases have organic radicals which are substituted by fluorine. Such silanes are described in detail in WO 92/21729. It is possible to use for this purpose hydrolysable silanes having at least one non-hydrolysable radical, which has the general formula

Rf(R)_{b}SiX_{(3-b)} (II)

in which X and R are defined as in formula (I), Rf is a nonhydrolysable group which has 1 to 30 fluorine atoms bonded to carbon atoms which are preferably separated from Si by at least two atoms, preferably an ethylene group, and b is 0, 1 or 2. R is in particular a radical without a functional group, preferably an alkyl group, such as methyl or ethyl. The groups Rf preferably contain 3 to 25 and in particular 3 to 18 fluorine atoms which are bonded to aliphatic carbon atoms. Rf is preferably a fluorinated alkyl group having 3 to 20 carbon atoms, and examples are CF₃CH₂CH₂-, C₂F₅CH₂CH₂-, n-C₆F₁₃CH₂CH₂-, i-C₃F₇OCH₂CH₂CH₂-, n-C₈F₁₇CH₂CH₂- and n-C₁₀F₂₁—CH₂CH₂-.

Examples of fluorosilanes which may be used are CF₃CH₂CH₂SiCl₂(CH₃), CF₃CH₂CH₂SiCl(CH₃)₂, CF₃CH₂CH₂Si(CH₃)(OCH₃)₂, C₂F₅—CH₂CH₂—SiZ₃, n-C₆F₁₃—CH₂CH₂SiZ₃, n-C₈F₁₇—CH₂CH₂—SiZ₃, n-C₁₀F₂₁—CH₂CH₂SiZ₃ with (Z=OCH₃, OC₂H₅ or Cl), i-C₃F₇O—CH₂CH₂CH₂—SiCl₂(CH₃), n-C₆F₁₃—CH₂CH₂—Si(OCH₂CH₃)₂, n-C₆F₁₃—CH₂CH₂—SiCl₂(CH₃) and n-C₆F₁₃—CH₂CH₂—SiCl(CH₃)₂.

The silanes can be prepared by known methods; cf. W. Noll, “Chemie und Technologie der Silicone” [Chemistry and technology of the silicones], Verlag Chemie GmbH, Weinheim/Bergstraβe (1968).

Examples of metal compounds which have a functional group are metal compounds of a metal M from the main groups III to V and/or the subgroups II to IV of the Periodic Table of the Elements. Compounds of Al, Ti or Zr are preferred. Examples of these are R_{c}MX_{4-c} (M═Ti or Zr and c=1, 2, 3), in which X and R are defined as above in formula (I), it also being possible for one R or a plurality of R together to represent a complexing agent, such as, for example, a β-dicarbonyl compound or a (mono)carboxylic acid. Zirconium and titanium tetraalcoholates in which some of the alkoxy groups have been replaced by a complexing agent, such as, for example, a β-dicarbonyl compound or a carboxylic acid, preferably a monocarboxylic acid, are preferred.

Surfactants may also be used as modifiers. Surfactants can form micelles. The modifiers discussed above are for the most part not surfactants, i.e. they do not form micelles even at high concentrations. This behaviour relates to the pure dispersant. In the presence of the particles, the modifiers do of course also undergo the chemical interactions with the particles which are described according to the invention. All conventional surfactants known to the person skilled in the art may be used. Usually, modifiers which are not surfactants, for example those discussed above, are preferred.

Any desired solvent may be used as dispersant provided that it does not, or does not substantially, dissolve the particles to be treated and is also inert or substantially inert to the modifier used. The solvents mentioned for step a) may be stated as examples. Frequently, it is expedient to carry out steps a) and b) in the same solvents.

The substances used according to the invention can be mixed with one another in any desired sequence. The mixing can be effected directly in the apparatus for the mechanical activation or beforehand in a separate container, for example a mixer. Preferably, otherwise no further additives are added, i.e. the mixture consists of at least one dispersant, at least one modifier, which in special cases may correspond to the dispersant, and the particles. Examples of additives which are optionally admixed are antifoams, press auxiliaries, organic binders, photocatalysts, colour-imparting compositions, sintering aids, preservatives and rheological additives. The addition of additives is necessary only if they are required for further processing. These additives can therefore be added even after the processing according to the invention. An advantage of prior addition may lie in the homogeneous mixture obtained as a result of the milling.

As a rule, strong shearing is effected for the mechanical activation, with the result that surface-modified particles are obtained. The mechanically activated process with strong shearing can be carried out using customary and known apparatuses, such as apparatuses for comminution, kneading or milling. Examples of suitable apparatuses are dispersers, turbo stirrers, jet dispersers, roll mills, mills and kneaders. Kneaders and mills are preferably used. Examples of mills and kneaders are mills having loose milling tools, such as ball mills, rod mills, tumbling mills, cone mills, tube mills, autogenous mills, planetary mills, vibration mills and stirred ball mills, shear roller kneaders, mortar mills and colloid mills.

The expedient temperature for the respective system can optionally be established by the person skilled in the art. The mechanically activated process is preferably effected at room temperature or ambient temperature (e.g. 15 to 30° C.), i.e. heating is not carried out. The mechanical activation may result in heating of the suspension. This may be desired. If required, however, cooling is also possible. Usually, cooling units are used to prevent a temperature increase up to the boiling point of the solvent. In the usual procedure, a temperature from ambient temperature to 70° C. or 60° C., preferably ambient temperature to less than 50° C., is reached during the mechanical activation. The temperature is preferably below the boiling point of the solvent used.

The duration of the mechanical activation depends in particular on the solids content of the suspensions used, on the dispersant and on the surface modifier, and may be several minutes to days.

The mechanical stress for the activation can also be produced in a two-stage or multistage embodiment. It may consist, for example, of upstream steps and a downstream step, it being possible for the modifier to be present in each step or only in at least one step, for example the last one. For example, in the case of milling with grinding medium, an upstream milling step with relatively coarse grinding medium can be added in order to achieve the optimum, efficient starting particle size for the final step.

The particle content of the suspensions which undergo the mechanically activated process with its strong shearing depends, inter alia, on the apparatus used. In the case of kneaders, the particle content is in general between 98 and 50% by volume of the suspension. With the use of mills, the particle content is in general up to 60% by volume of the suspension. The particle/modifier weight ratio is in general 100:1 to 100:35, in particular 100:2 to 100:25 and particularly preferably 100:4 to 100:20.

The particle/grinding medium ratio present in the grinding space inevitably arises out of the solids content of the suspension and the degree of filling with grinding balls which is used and the bulk density of the grinding balls.

The mechanically activated process can be promoted by additional energy input (in addition to the acting mechanical energy), for example by means of microwaves and/or ultrasound, it being possible for these two methods also to be used simultaneously. The energy input into the dispersion is effected directly in the apparatus for the mechanical activation but may also be effected outside the apparatus in the product circulation.

The process can be carried out both continuously in one-pass operation or multi-pass operation (pendulum method) or by the circulation method and batchwise in batch operation.

As a result of the mechanical activation in the presence of the activating agent, modifier is at least proportionately chemically bonded to the particles, which as a rule are simultaneously deagglomerated and/or deaggregated.

After step b) highly disperse surface-modified nanoscale particles of less than 100 nm can be obtained. The mean particle diameter of the particles obtained is in general not more than 50 nm, preferably not more than 30 nm and particularly preferably not more than 20 nm. By means of the process according to the invention, it is even possible to produce surface-modified, crystalline and/or densified, doped and undoped nanoparticles or colloids having a mean particle diameter or a mean smallest dimension down to about 1 nm.

Here, unless stated otherwise, the mean particle diameter is understood as meaning the particle diameter based on the volume average (d₅₀ value), a UPA (Ultrafine Particle Analyzer, Leeds Northrup (laser optical, dynamic laser light scattering)) being used for the measurement. For the determination of very small particles (e.g. less than 3.5 nm) it is also possible to use quantitative image analyses using electron microscopy methods (e.g. via HR-TEM). Since the particle diameters in the image plane are determined in these methods, the values may differ from the values determined by UPA, since UPA measurements give particle diameters which can be regarded as the mean three-dimensional diameter. Particle diameters are sometimes also referred to as particle sizes.

The mean particle diameter is also sometimes stated as the mean smallest diameter, which may be the mean diameter or the mean height or width, depending on which is smaller. For example, the mean smallest dimension is the mean particle diameter for spherical particles and the mean height for lamellar particles. Here too, the mean smallest dimension relates to the volume average.

Methods for determining this smallest dimension and the details of these methods are known to the person skilled in the art. A further method used is, for example, the X-ray disc centrifuge.

The nanoparticles can be obtained as a powder from the resulting surface-modified, doped and undoped colloids by removing the dispersant. Any known method can be used for the removal, for example evaporation, centrifuging or filtration.

The bound modifier molecules, through the functionality of which the properties of the particles can be controlled, are present on the surface of the particles obtained. The particles can then be taken up again in the same or another suitable dispersant, relatively little or no aggregation being observed, so that the mean particle diameter can be substantially preserved.

The surface-modified, crystalline and/or densified, doped and undoped nanoparticles or colloids can be further worked up by known methods. They can, for example, be reacted with other surface modifiers, or they can be dispersed in organic or aqueous solvents, and soluble polymers, oligomers or organic monomers or sols or additives, such as, for example, the above-mentioned ones, can be admixed. Such mixtures, working-up operations or the surface-modified, crystalline and/or densified, doped and undoped nanoparticles or colloids as such can be used, for example, for the production of coatings or mouldings or for other applications.

Examples of possible fields of use of the surface-modified, crystalline and/or densified, doped or undoped nanoparticles or colloids or of mixtures which comprise these, in particular for corresponding ZrO₂ particles, include the production of mouldings, films, membranes and coatings or of compounds or hybrid materials. The products, in particular the coatings or layers, may serve for a very wide range of purposes, for example as coatings having low-energy surfaces or as abrasion-resistant, oxygen ion-conductive, microbicidal, photocatalytic, microstructurable or microstructured, holographic, conductive, UV-absorbing, photochromic and/or electrochromic products or layers.

The following examples serve for further explaining the present invention.

### EXAMPLES

### Example 1

A mixture of 1720 g of Y(NO₃)₃.4H₂O and 25.5 kg of zirconium propylate was dissolved in 12.8 kg of ethanol. The resulting solution was added dropwise with stirring at room temperature to 32 kg of an aqueous ammonia solution (pH 10-11). After the end of the addition, the suspension was thermally treated in a continuously operating tubular reactor at a temperature of 240° C. and a pressure of 50 bar. The average residence time of the suspension in the reactor is at least 30 minutes. The suspension thus obtained was adjusted to pH=7.8-8.3 by addition of ammonia solution with stirring, sedimentation taking place after the end of the stirring. The supernatant was removed. Once again distilled water was added with stirring and the pH was once again adjusted to pH=7.8-8.3. This wash process was repeated until the conductivity of the supernatant reached a value of <10 μS. The supernatant was removed, and a solids-containing suspension was obtained and was freeze-dried. About 900 g of this freeze-drying powder were initially introduced into a two-roll kneader (max. fill volume 2 litres). After addition of 50 g of water and 135 g of TODA (3,6,9-trioxadecanoic acid), a highly viscous paste was obtained by kneading. The highly viscous material was kneaded at a temperature of <55° C. for about 6 hours. This gave an 83% strength by weight paste of nanoscale ZrO₂ (cubic, stabilized with 4 mol of Y₂O₃), which had been surface-modified with TODA and had an average particle size of 4-8 nm (TEM) and a mean particle diameter d₅₀=13 nm (UPA).

### Example 2

1085 g of the paste prepared in Example 1 (83% by weight of ZrO₂) were dispersed in 715 g of water by mechanical stirring. This gave a 50% strength by weight suspension of nanoscale ZrO₂ (cubic, stabilized with 4 mol of Y₂O₃) surface-modified with TODA and having an average particle size of 4-8 nm (TEM) and a mean particle diameter d₅₀=14 nm (UPA).

### Example 3

1085 g of the paste prepared in Example 1 (83% by weight of ZrO₂) were converted into a powder by freeze drying. This gave a nanoscale ZrO₂ powder (cubic, stabilized with 4 mol of Y₂O₃) surface-modified with TODA and having an average particle size of 4-8 nm (TEM) and a mean particle diameter d₅₀=16 nm (UPA).

### Example 4

970 g of ethanol, 400 g of the freeze-dried powder from Example 1 and 30 g of acetylacetone were introduced into a reaction vessel and mixed for 30 min with mechanical stirring. The mixture obtained was milled in a stirred ball mill for 6 h (Drais Pearl Mill PML-H/V, grinding space lined with zirconium oxide), gross grinding space volume 1.21, 4100 rpm, 1700 g of grinding balls (zirconium silicate), ball diameter 0.3-0.4 mm, continuous operation by encirculation method). This gave a 40% strength by weight suspension of nano-scale ZrO₂ (cubic, stabilized with 4 mol of Y₂O₃) surface-modified with acetylacetone and having an average particle size of 4-8 nm (TEM) and a mean particle diameter d₅₀=12 nm (UPA).

### Example 5

6.4 kg of ethanol were added to 25.5 kg of zirconium propylate and added dropwise with stirring at room temperature to 32 kg of an aqueous, slightly ammoniacal solution (pH=8). After the end of the addition, the suspension was thermally treated in a continuously operating tubular reactor at a temperature of 240° C. and a pressure of 50 bar. The average residence time of the suspension in the reactor is at least 30 minutes. The suspension thus obtained is adjusted to pH=7.8-8.3 by addition of ammonia solution with stirring, sedimentation taking place after the end of the stirring. The supernatant was removed. Distilled water was once again added with stirring and the pH was once again adjusted to pH=7.8-83. This wash process was repeated until the conductivity of the supernatant reached a value of <10 μS. The supernatant was removed, and a high-solids paste having a solids content of 40% by weight was obtained by subsequent centrifuging. 60 g of TODA was added to 1 kg of this paste and mechanical stirring was effected for 30 min. The suspension obtained is milled in a stirred ball mill for 4 h (Drais Pearl Mill PML-H/V, grinding space lined with zirconium oxide, gross grinding space volume 1.21, 4100 rpm, 1700 g of grinding balls, zirconium silicate, ball diameter 0.3-0.4 mm, continuous operation by the circulation method). This gave a 37.7% by weight suspension of nanoscale ZrO₂ which had been surface-modified with TODA and had an average particle size of 8-10 nm (TEM) and a mean particle diameter d₅₀=13 nm (UPA).

### Example 6

1 kg of the 40% strength by weight ZrO₂ paste prepared in Example 5 was freeze-dried. 60 g of N-(2-hydroxyethyl)iminodiacetic acid were added to the powder obtained therefrom in 600 g of water, and mechanical stirring was effected for 30 min. The mixture obtained was milled in a stirred ball mill for 6 h (Drais Pearl Mill PML-H/V, grinding space lined with zirconium oxide, gross grinding space volume 1.21, 4100 rpm, 1700 g of grinding balls, zirconium silicate, ball diameter 0.3-0.4 mm, continuous operation by the circulation method). This gave a 37.7% by weight suspension of nanoscale ZrO₂ surface-modified with N-(2-hydroxyethyl)iminodiacetic acid and having an average particle size of 8-10 nm (TEM) and a mean particle diameter d₅₀=11 nm (UPA).

### Example 7

2.5 kg of the 40% strength by weight suspension obtained in Example 5 were freeze-dried. The powder resulting therefrom was initially introduced into a 2-roll kneader (max. fill volume 2 litres). After addition of 50 g of water and 150 g of TODA, a highly viscous paste was obtained by kneading. The highly viscous material was kneaded at a temperature of <55° C. for about 6 hours. This gave an 83% strength by weight paste of nanoscale ZrO₂ surface-modified with TODA and having an average particle size of 8-10 nm (TEM) and a mean particle diameter d₅₀=18 nm (UPA).

### Example 8

1200 g of the paste prepared in Example 7 (83% by weight of ZrO₂) were dispersed in 1300 g of water by mechanical stirring. This gave a 40% strength by weight suspension of nanoscale ZrO₂ surface-modified with TODA and having an average particle size of 8-10 nm (TEM) and a mean particle diameter d₅₀=18 nm (UPA).

### Example 9

1200 g of the paste prepared in Example 7 (83% by weight of ZrO₂) were converted into a powder by freeze drying. This gave a nanoscale ZrO₂ powder surface-modified with TODA and having an average particle size of 8-10 nm (TEM) and a mean particle diameter d₅₀=20 nm (UPA).

### Example 10

3200 g of distilled water were initially introduced into a stirred container. 2550 g of zirconium propylate are mixed with 640 g of ethanol and added dropwise to the water at room temperature with stirring. 7200 ml of the precipitated suspension were introduced into a 10 litre batch autoclave. The autoclave is flushed three times with nitrogen at a pressure of 10 bar. The suspension is autoclaved at 10 bar admission pressure (N₂) at a temperature of 230° C. for 3 hours. The. pressure is about 50 bar. The suspension thus obtained was adjusted to pH=7.8-8.3 by addition of ammonia solution with stirring, sedimentation taking place after the end of the stirring. The supernatant was removed. Distilled water was once again added with stirring and the pH was once again adjusted to pH=7.8-8.3. This wash process is repeated until the conductivity of the supernatant has reached a value of <10 μS. The supernatant was removed, and a solids-containing suspension was obtained and was freeze-dried. 900 g of this freeze-dried powder were initially introduced into a 2-roll kneader (max. fill volume 2 litres). After addition of 50 g of water and 112.5 g of TODA, a highly viscous paste was obtained by kneading. The highly viscous material was kneaded at a temperature of <55° C. for about 8 hours. The kneaded material was dispersed in 735.5 g of water by mechanical stirring. This gave a 50% strength by weight suspension of nanoscale ZrO₂ surface-modified with TODA and having an average particle size of 8-12 nm (TEM) and a mean particle diameter d₅₀=18 nm (UPA).

1.-24. (canceled)

25. A process for the production of a suspension of crystalline and/or densified, surface-modified nanoscale particles in a dispersant, wherein the process comprises:
(a) heat-treating a suspension of amorphous or semicrystalline, non-surface-modified nanoscale particles in a first dispersant to obtain non-surface-modified nanoscale particles which are at least one of crystallized and densified; and
(b) mechanically activating, in the presence of at least one modifying agent, the particles obtained according to (a) which are present as a suspension in the first dispersant or in a second dispersant which is different from the first dispersant to obtain a suspension of crystalline and/or densified nanoscale particles which are surface-modified by the at least one modifying agent.

26. The process of claim 25, wherein in (a) the particles are heat-treated at elevated pressure.

27. The process of claim 26, wherein in (a) the particles are heat-treated at a pressure of at least 5 bar.

28. The process of claim 25, wherein in (a) the particles are heat-treated at a temperature of at least 60° C.

29. The process of claim 25, wherein in (b) the at least one modifying agent is chemically bonded to a surface of the particles.

30. The process of claim 25, wherein in (b) mechanical activation is effected by an apparatus which exerts a shearing force on the suspension.

31. The process of claim 30, wherein the apparatus comprises at least one of a comminution apparatus, a kneading apparatus and a milling apparatus.

32. The process of claim 25, wherein in (b) mechanical activation is effected by at least one device selected from dispersers, turbo stirrers, jet dispersers, roll mills, mills and kneaders.

33. The process of claim 25, wherein in (b) mechanical activation is carried out without external heating.

34. The process of claim 25, wherein in (b) mechanical activation is carried out in one stage.

35. The process of claim 25, wherein in (b) mechanical activation is carried out in two or more stages, at least one of the stages being carried out in the presence of the at least one modifying agent.

36. The process of claim 25, wherein in (b) mechanical activation is promoted by an additional energy input into the suspension.

37. The process of claim 36, wherein the additional energy input comprises at least one of ultrasound and microwaves.

38. The process of claim 25, wherein in (b) the first or second dispersant is used as a modifying agent.

39. The process of claim 25, wherein in (b) a weight ratio of particles to the at least one modifying agent is from 100:1 to 100:35.

40. The process of claim 25, wherein a mean diameter of the particles obtained in (b) is not larger than 20 nm.

41. The process of claim 25, wherein the suspension obtained in (a) is purified at least partially to remove process by-products before (b) is carried out.

42. The process of claim 41, wherein the particles in the suspension obtained according to (a) are flocculated, a resultant supernatant is removed and a sedimentation product is diluted with a fresh dispersant to at least partially exchange spent dispersant containing the process by-products.

43. The process of claim 25, wherein the suspension to be heat-treated according to (a) is obtained by a process comprising
(i) subjecting molecular precursors of the amorphous or semicrystalline, non-surface-modified nanoscale particles in a dispersant to at least one of a condensation reaction and a precipitation reaction to obtain the amorphous or semicrystalline, non-surface-modified nanoscale particles;
(ii) suspending a powder of the nanoscale particles obtained according to (i) in the dispersant; or
(iii) exchanging the dispersant of a suspension of the amorphous or semicrystalline, non-surface-modified nanoscale particles for a desired dispersant.

44. The process of claim 25, wherein the particles comprise doped particles.

45. The process of claim 25, wherein the particles comprise at least one of oxide particles and hydrated oxide particles.

46. The process of claim 25, wherein the particles comprise one or more compounds of one or more of Mg, Ca, Sr, Ba, Al, Si, Sn, Pb, Sb, Bi, Ti, Zr, V, Mn, Nb, Ta, Cr, Mo, W, Fe, Co, Ru, Zn, Ce, Y, Sc, Eu, In and La.

47. The process of claim 46, wherein the particles comprise at least one of oxide particles and hydrated oxide particles.

48. The process of claim 25, wherein the particles comprise one or more compounds selected from ZrO₂, TiO₂, aluminium-coated rutile, SnO₂, Al₂O₃, ITO (indium tin oxide), ATO (antimony-doped tin oxide), In₂O₃, Y₂O₃, CeO₂, ZnO, manganese oxides, iron oxides, BaO or CaO, doped oxides thereof and hydrated oxides thereof.

49. The process of claim 48, wherein the particles comprise ZrO₂.

50. A process for the production of crystalline and/or densified, surface-modified nanoscale particles, wherein the process comprises removing the dispersant from the particle suspension produced by the process of claim 25.

51. A process for the production of a suspension of crystalline and/or densified, surface-modified nanoscale particles in a dispersant, wherein the process comprises:
(a) heat-treating a suspension of amorphous or semicrystalline, non-surface-modified nanoscale particles in a first dispersant at a pressure of at least 5 bar and at a temperature of at least 60° C. to obtain non-surface-modified nanoscale particles which are at least one of crystallized and densified; and
(b) activating by mechanical stress which comprises shearing the particles obtained according to (a) which are present as a suspension in the first dispersant or in a second dispersant which is different from the first dispersant in the presence of at least one modifying agent at a weight ratio of particles to the at least one modifying agent of from 100:1 to 100:35 to obtain a suspension of crystalline and/or densified nanoscale particles which are surface-modified by the at least one modifying agent.

52. The process of claim 51, wherein in (b) the at least one modifying agent is chemically bonded to a surface of the particles.

53. The process of claim 51, wherein in (b) mechanical activation is promoted by an additional energy input which comprises at least one of ultrasound and microwaves.

54. The process of claim 52, wherein the particles comprise ZrO₂.

55. The process of claim 54, wherein a mean diameter of the particles obtained in (b) is not larger than 20 nm.
